(19) United States
(12) Patent Application Publication
(10) Pub. No.: US 2010/0167415 A1
(43) Pub. Date: Jul. 1, 2010

(54) ALIQUOTTING DEVICE

(75) Inventor: Dieter Schmiedl, Schmolln (DE)

Correspondence Address: KNOBBE MARTENS OLSON & BEAR LLP, 2040 MAIN STREET, FOURTEENTH FLOOR, IRVINE, CA, 92614, US

(73) Assignee: EPPENDORF AG, Hamburg (DE)

(21) Appl. No.: 12/650,314

(22) Filed: Dec. 30, 2009

(30) Foreign Application Priority Data
Dec. 30, 2008 (DE) 202008017181.4

(51) Int. Cl. G01N 1/00; B01L 3/02; B01L 3/14; G01N 1/02

(52) U.S. Cl. 436/174; 422/100; 422/102

(57) ABSTRACT

Aliquotting device on the basis of a micro litre test tube (1), characterized in that the inner surface of the micro litre test tube (1) is provided at least partly with collecting means, such as cotton wool coatings (4), cutting edges (5), brushes (6) or barbed hooks, rough surfaces and the like.

### BACKGROUND OF THE DISCLOSURES

(1) Field of the Invention

The invention pertains to an aliquotting device for separating sample material in a contamination free way, which material rests on swabs having a shaft or on micro litre pipette tips. The device is also suitable for subsequent storage of the collected aliquot or sample.

The device is designed for securing samples to be used as evidence in microbiologic, virologic, genetic, medical, veterinary medical, forensic, criminalistic and technical fields. It is further designed as a component of an apparatus system for sampling, identifying, sample distributing/aliquotting, storing, and further processing and providing of samples, respectively.

(2) Description of Related Art

Swabs of cotton wool with shafts—or shaft swabs—have proven to be useful as sample carriers for securing evidence in the above described technical fields. In this respect the term “cotton wool” comprises varying textile materials having different hydrophilic characteristics. Said swabs mostly consist of a shaft/stick made of wood, metal or plastics to which a piece of cotton wool is provided on one or both ends, which serves as the actual sample collector.

According to DE 20 2007 001 898 a swab having a shaft is fixed in a recess of a closure plug of a sample container.

A further generic swab is described in German utility model 20 2008 013 218.5.

Here, a sample carrier in form of a micro litre pipette tip is provided in the region of the tip's pointed outlet which carries a sample collector in form of a cotton wool head. Said sample carrier can be wetted from the inside of the micro litre pipette tip.

A forensic pipette according to German utility model 20 2008 013 219.3 is suitable for wetting, holding and handling of such sample carriers.

In general, the purpose of securing samples to be used as evidence resides in retrieving DNA in appropriate purity and molecular integrity.

Typically, a sample is taken or collected from a substrate by dry or wet rubbing off said substrate or wiping. The collected sample is then directed to further analytical testing. Thereby the above described means are used.

A difficulty resides in that a collected DNA sample will only last for a short time period, since DNA will be easily degraded by omnipresent endonucleases. Under exposure to said nucleases, mostly of bacterial origin, DNA is degraded to short fragments which are worthless in view of permanently securing evidence. The most important risk factors are inappropriate storing conditions, namely incompatible high temperature and humidity, acting UV-light, and contaminations. Said factors can lead to analytical interferences either individually or in combination

Evaluating the sample material is often performed with a considerable time lag to the actual collection of the sample. Therefore, storing the samples is an obligatory requirement. Because of the high juridical relevance involved in DNA sample materials found and secured, said material must on the one hand be protected from qualitative loss or falsification of all sorts. On the other hand an essential problem is that said secured sample material exists only in low amounts, which are consumed quickly by chemical analysis. Although sufficient DNA amounts usually exist for analytical studies after polymerase chain reaction (PCR) has been carried out, it is nevertheless non satisfactory that the original sample material is not available any longer for additional control studies.

Thus, the purpose of the present invention is to be seen in splitting original samples resting on sample carriers in the form of shaft swabs or micro litre pipette tips for at least a single time.

### SUMMARY

The problem to be solved underlying the present invention is thus to be seen in the development of a technical device for aliquotting, and if applicable, also for subsequent storing of sample materials, which are resting on sample carriers. Relevant sample carriers for this purpose are the widely used swabs with shafts or shaft swabs, as well as newly developed micro litre pipette tips which - according to German utility model 20 2008 013 218.5—have a cotton wool head applied thereto.

### BRIEF DESCRIPTION OF THE DRAWINGS

FIGS. 1-3 show a micro litre test tube having a cotton wool coating according to some embodiments of the present invention.

FIGS. 4-6 show a micro litre test tube having brushes according to some other embodiments of the present invention.

FIGS. 7-9 show a micro litre test tube having cutting edges according to still some other embodiments of the present invention.

### DETAIL DESCRIPTION OF THE DISCLOSURES

This problem has been solved by the provision of an aliquotting device on the basis of a micro litre test tube, wherein the inner surface of the micro litre test tube is provided at least partly with collecting means, such as cotton wool coatings, cutting edges, brushes or barbed hooks, rough surfaces and the like.

In an embodiment of the invention only the tip of the micro litre test tube is provided with the collecting means.

In another embodiment of the invention the tip of the micro litre test tube is filled with a cotton wool coating.

In a further embodiment of the invention the cutting edges, brushes or barbed hooks are oppositely oriented.

In still another embodiment of the invention said micro litre test tube which is predominantly made of plastics is designed in such a way that the aliquotting of sample material by means of an insertable micro litre pipette tip is feasible, provided that sample material can alternatively also be aliquotted from a shaft swab.

In yet another embodiment of the invention said micro litre pipette tip is in active connection with the micro litre pipette, the handling of which is carried out manually or automatically.

After securing and professionally storing the samples to be used as evidence, said samples are usually analyzed in a laboratory, which is often accompanied by loss of the original sample. Thus, for subsequent or later control studies or continuative analytics no further original material will be available.

The method applied by some users in which each sample is taken/collected twice, whereby two different swabs are used, is as a matter of fact incorrect, since strictly speaking two different samples have been taken. It may not be assumed that identical features are fixed on both swabs used. Analyzing the second swab, which is used as storage sample, does not necessarily deductively represent the findings of the first swab, making its analysis juridically questionable.

Hence, only part of the original sample should be used for analysis while the remainder should be professionally stored for additional analyses.

Aliquotting the original sample is not uncomplicated, since it has to be anticipated that (additional) contamination may occur. What is more, such laboratory work is extremely time-consuming since it can only be performed manually.

The typical and general method of splitting a sample comprises cutting some cotton wool with a fresh and sterile scalpel or other suitable cutting means from each individual shaft swab tip, and transferring the cut cotton wool to a test tube, a microcentrifuge tube such as an Eppendorf tube, or any other reaction container for further processing. Some users even abandon the option of making aliquots. Instead, the tip of the cotton wool carrier is completely transferred into the test tube. For this purpose shaft swabs having a predetermined breaking point or the like are used. In this respect a further disadvantage resides in the fact that part of the shaft, which mostly consists of wood, metal or plastics, will also run through the further chemical processes, which involves the risk of interferences with the analytics.

To implement the present invention it is proposed to redesign e.g. a known micro litre test tube in such a way, that said tubes can be used as sample splitter/aliquotter for the above purpose. Thereto, the inner surface of a respective tube is furnished with collecting means for removing sample material of an inserted sample carrier.

As used herein, the term microlitre test tube encompasses standard laboratory devices and reaction containers such as microcentrifuge tubes—e.g. Eppendorf tubes—and comparable tubes, vessels, and the like. Basically any item adapted for storing samples to be used as evidence may be used in the present invention.

As used herein, the term collecting means comprises distinctly formed cotton wool coatings, cutting edges, brushes or (barbed) hooks, rough surfaces and the like. Said cutting edges, brushes and barbed hooks, respectively, may be oriented in the same or in opposite direction within the micro litre test tube.

In principle, the whole inner surface of the micro litre test tube is available for attaching said means and forming as sampling/collecting means, respectively. However, it will also be sufficient if only the lower pointed part of such tube is used for this purpose.

### EXAMPLE

In the following embodiment of the invention an aliquotting device according to the present invention is described in more detail with reference to the drawings. The device is also suitable for subsequent storing of the aliquot.

All figures show known micro litre test tubes 1 which are mainly made of plastics. Said tubes are modified in such a way that they can take off/collect sample material from a micro litre pipette tip 2, wherein samples may also be collected from a shaft swab or swaptip 3.

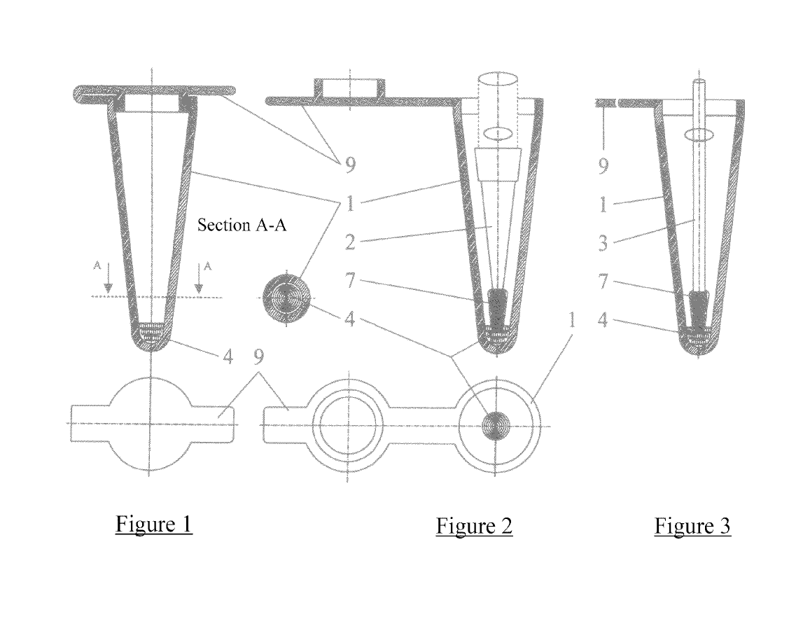

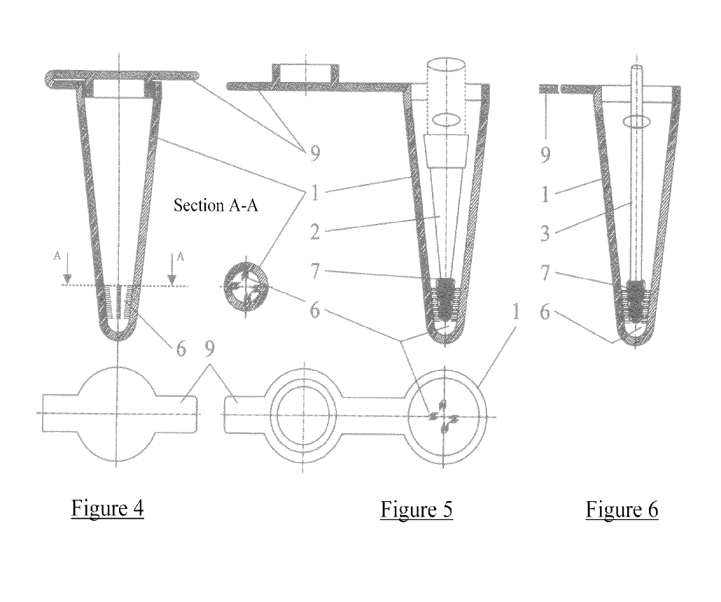

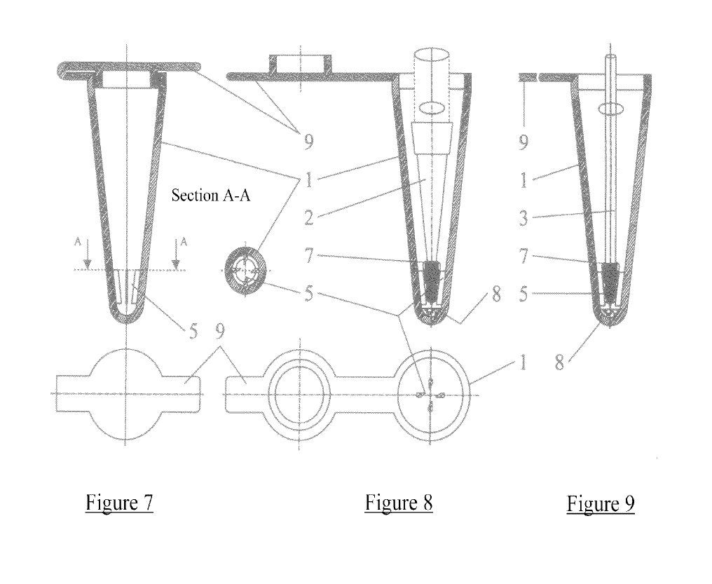

In each of FIG. 1, FIG. 4 and FIG. 7 a micro litre test tube 1 is indicated, having a cotton wool coating 4, brushes 6 and cutting edges 5, respectively, wherein the latter two are arranged in opposite directions. FIG. 2, FIG. 5 and FIG. 8 show micro litre test tube 1 having an inserted micro litre pipette tip 2, while FIG. 3, FIG. 6 and FIG. 9 show micro litre test tubes 1 into which shaft swabs 3 have been inserted.

The differently designed collecting means are each arranged in the region of the lower inner surface of the micro litre test tube 1.

According to FIGS. 1, 2 and 3 a cotton wool coating 4 is provided at the bottom of micro litre test tube 1. Said coating is suitable as collecting means, regarding the sort of material, stack/batch length and machining, even if the fibres of the cotton wool head 7 are felted, glued, fused or otherwise compacted/hardened.

The micro litre test tube 1, shown in FIGS. 4, 5 and 6, has at least one and preferably more brushes 6 as substitute for the cotton wool coating 4, which brushes are preferably arranged/oriented in opposite directions. Said brushes can be replaced, if applicable, by boarder bristles, hook-and-loop like barbed hooks or otherwise roughened elements of the tube materials.

FIGS. 7, 8 and 9 show a micro litre test tube 1, wherein at least one, preferably more oppositely oriented cutting means 5 are provided as collecting means. Said aliquotting device is particularly suitable for collecting samples from felted, glued, fused or otherwise compacted/hardened material of wet or dry cotton wool heads 7. The arrangement of the cutting means 5 allows operation in opposing directions, whereby a low amount of aliquot 8 is removed.

All described modifications of the aliquotting device of the invention have a micro litre test tube 1, which advantageously has a formed lid-like closure 9, and which can simultaneously be used as storage container or test/reaction container for the collected aliquot 8.

The thus little depleted original sample carriers can be stored as storage sample immediately after sample splitting. Said samples correspond in their composition completely to the splitted aliquots.

According to the configuration of the micro litre test tube 1 having said described collecting means, a mechanical removal of sample material from a sample carrier is possible by slightly turning the same within the tube. The principle of sample splitting according to said technology is based on the fact that cotton wool consists of natural, semi synthetic or synthetic fibre material of different stack lengths. The cotton wool is mostly applied on a carrier wad-like. Based on its micro structure cotton wool can non-destructively rub off surfaces and bind collected substances within the fibre-structure based on its hydrophilic and absorptive characteristics. This material thinning however shall not lead to a mechanical disruption of the original cotton wool tampon or even to a complete stripping/separation of the cotton wool carrier. The amount of collectable fibre material depends—besides of the constructive nature of the sample splitter—also on the stack length of the cotton wool material, the strength of cross linked fibres, and on the pressure and duration of the turning motion employed.

Further, it is possible to collect a secondary smear of the original sample. In this case the collecting means is a fixedly inserted sterile cotton wool bed at an inner bottom of the micro litre test tube 1.

After wetting the same with sterile water the primary sample carrier is inserted and turned under a smooth moderate pressure, whereby the sample is aliquotted/splitted.

Thereafter, the original must be dried again before storing.

After the smear has been taken the splitted aliquot can be further processed as usual.

### REFERENCE LIST

1 Micro litre test tube,
2 Micro litre pipette tip,
3 Swab with shaft/ Shaft swab,
4 Cotton wool coating,
5 Cutting edge,
6 Brush,
7 Cotton wool head,
8 Aliquot,
9 Closure.

What is claimed is:

1. Aliquotting device comprising a micro litre test tube, said micro litre test tube comprising a sample collecting part, wherein said sample collecting part is placed in the inner surface of the micro litre test tube, and configured to collect at least part of a sample provided by a sample carrier.

2. The device according to claim 1, wherein the sample collecting part comprises one or more selected from the group consisting of cotton wool, a cutting edge, a brush, a barbed hook, and a rough surface.

3. The device according to claim 1, wherein the micro litre test tube comprises a tip, and the sample collecting part is positioned in said tip.

4. The device according to claim 3, wherein the tip of the micro litre test tube is filled with cotton wool.

5. The device according to claim 2, wherein a plurality of cutting edges, brushes or barbed hooks are oppositely oriented in the inner space of said micro litre test tube.

6. The device according to claim 1, wherein said micro litre test tube is made of plastics.

7. The device of claim 1, wherein the sample carrier comprises a micro litre pipette tip or a shaft swab, and the micro litre test tube is designed in such a way that the micro litre pipette tip or the shaft swap comprising the sample is inserted into the micro litre test tube to aliquot the sample.

8. The device according to claim 7, wherein the micro litre pipette tip is in active connection with a micro litre pipette, and its handling is carried out manually or automatically.

9. A method of aliquotting a sample, the method comprising:
providing the sample with a sample carrier to the device of claim 1; and
collecting at least part of the sample present in the sample carrier with the sample collecting part of the micro litre test tube.
